(19) United States
(12) Patent Application Publication
(10) Pub. No.: US 2008/0274901 A1
(43) Pub. Date: Nov. 6, 2008

(54) COMPOSITE ELECTRICAL CONDUCTORS AND METHOD FOR THEIR MANUFACTURE

(75) Inventors: Bartek A. GLOWACKI, Cambridgeshire (GB); Andrzej MORAWSKI, Otwock (PL)

Correspondence Address: NIXON & VANDERHYE, PC, 901 NORTH GLEBE ROAD, 11TH FLOOR, ARLINGTON, VA, 22203, US

(73) Assignee: CAMBRIDGE ENTERPRISE LIMITED, Cambridge (GB)

(21) Appl. No.: 12/098,475

(22) Filed: Apr. 7, 2008

Related U.S. Application Data
(60) Provisional application No. 60/907,590, filed on Apr. 10, 2007.

(30) Foreign Application Priority Data
Apr. 10, 2007 (GB) 0706919.8

(51) Int. Cl. H01B 12/00; H01B 7/18; H01R 43/00

(52) U.S. Cl. 505/230; 174/102 R; 29/868

(57) ABSTRACT

An elongate composite electrical conductor with at least one superconducting core region including processed core material surrounded by sheath material such as Cu. The processed core material has a peripheral portion of ex situ reacted MgB₂ and a central portion of in situ reacted MgB₂. The ex situ MgB₂ is interposed between the in situ reacted MgB₂ and the sheath material and reduces unwanted reactions. Also disclosed are methods of forming the composite electrical conductor, including hot isostatic pressing.

### BACKGROUND TO THE INVENTION

1. Field of the Invention

The present invention relates to composite electrical conductors and methods for manufacturing composite electrical conductors. The invention has particular relevance for the Mg—B system superconducting materials.

2. Related Art

Superconductivity for the phase MgB₂ was first reported in 2001 (Nagamatsu J, Nakagawa N, Muranaka T, Zenitani Y and Akimitsu J, “Superconductivity at 39 K in magnesium diboride”, 2001, Nature 410 63-64), demonstrating a superconducting transition temperature T_{c} of 39 K. This was followed by an extensive worldwide research effort into forming useful conductors incorporating this superconducting material. A composite superconductor incorporating MgB₂ was reported in the same year (B A Glowacki, M Majoros, M Vickers, J E Evetts, Y Shi and I McDougall, “Superconductivity of powder-in-tube MgB₂ wires”, Supercond. Sci. Technol. 14 (2001) 193-199). This composite superconductor was a MgB₂ PIT (powder-in-tube) conductor using a Cu sheath material. This paper disclosed that a Cu sheath is a preferred material since B is insoluble in Cu and the alpha phase of the Mg—Cu binary phase has a narrow range of existence. In one production route, a mixture of Mg and B powder is used and then reacted in situ to form MgB₂ after mechanical deformation of the filled tube to form the conductor shape. In another production route, pre-reacted MgB₂ powder is used (the “ex situ” technique), and the filled tube is mechanically deformed to produce the conductor shape and then subjected to a heat treatment.

Dunand (Dunand D C, “Synthesis of superconducting Mg—MgB₂ composites”, Appl. Phys. Lett. 2001, Vol. 79, No. 25, p. 17) discloses the fabrication of metal matrix composite conductors formed by liquid-metal infiltration of MgB₂ powder with molten Mg at 800° C. under pressure. In a different method, a preform of B powder was infiltrated with molten Mg at 700° C. and subsequently annealed at 950° C. to increase the MgB₂ content. The measured transport current of the composites was low, and the superconducting transition was not sharp.

Majoros et al (M Majoros, B A Glowacki and M E Vickers, “50 K anomalies in superconducting MgB₂ wires in copper and silver tubes”, Supercond. Sci. Technol. 15 (2002) 269-275) investigated anomalies at around 50 K found in MgB₂ conductors formed via a PIT method using copper and silver sheaths. Conductors were formed both via an in situ route and via an ex situ route. In situ samples were formed using a mixture of Mg powder and B powder in either Cu or Ag tubes. Ex situ samples were formed using a pre-reacted MgB₂ powder in Ag tubes. This work investigated the Cu—MgB₂ interface and found evidence of the MgCu₂ phase.

Komori et al (K. Komori, K. Kawagishi, Y. Takano, H. Fujii, S. Arisawa, H. Kumakura, M. Fukutomi, K. Togano, “Approach for the fabrication of MgB₂ superconducting tape with large in-field transport critical current density”, Appl. Phys. Lett. 2002, Vol. 81, No. 6, pp. 1047-1049) fabricated conductors by deposition of a MgB₂ film on a Hastelloy tape with a buffer layer, via pulsed laser deposition. The authors suggest a better J_{c}-B (i.e. critical current density vs magnetic field strength) dependence up to 10 T at 4.2 K than Nb—Ti wires. After heat treatment, the grain size in the MgB₂ layer is about 10 nm. There are also MgO particles present, of around the same size. The authors suggest that the improved properties of this conductor are due to the increase effect of grain boundary pinning, due to the small grain size.

Giunchi et al (G. Giunchi, S. Ceresara, G. Ripamonti, A. Di Zenobio, S. Rossi, S. Chiarelli, M. Spadoni, R. Wesche and P. L. Bruzzone, “High performance new MgB₂ superconducting hollow wires”, Superconductor Science and Technology 16 (2003) 285-291) disclose the formation of MgB₂ hollow wires having a soft steel sheath. The steel sheath has a niobium internal liner. During manufacture, a magnesium rod is placed in the steel sheath and surrounded by fine-grained boron powder. The conductor is annealed at 750-950° C. for 1-3 hours to form MgB₂. The Mg migrates from the centre of the wire to infiltrate the B powder, leading to a hollow conductor.

Feng et al (W. J. Feng, T. D. Xia, T. Z. Liu, W. J. Zhao, Z. Q. Wei, “Synthesis and properties of Mg_{(1-X)}CuₓB₂ bulk obtained by self-propagating high-temperature synthesis (SHS) method at low temperature”, Physica C 425 (2005) 144-148) investigated the synthesis and properties of Mg₍₁₋ₓ₎CuₓB₂ bulk samples obtained by a self-propagating high temperature synthesis method, started at a temperature of 250-350° C. and lasting for 3-5 seconds. Some Cu atoms substitute for Mg atoms in MgB₂ and some MgCu₂ is formed. T_{c} is 36.5 K with a sharp transition. The authors speculate that the advantageous superconducting properties of the material in an applied magnetic field at 10 K are enhanced by good grain connectivity, small grain size and the presence of small MgCu₂ particles in the samples.

Glowacki et al (B A Glowacki, M Majoros, M Vickers, M Eisterer, S Toenies, H W Weber, M Fukutomi, K Komori and K Togano, “Composite Cu/Fe/MgB₂ superconducting wires and MgB₂/YSZ/Hastelloy coated conductors for ac and dc applications”, Supercond. Sci. Technol. 16 (2003) 297-305) present a study of MgB₂ multifilamentary conductors and coated conductors. They discuss the “peak effect” (peak in J_{c} at high magnetic field) for germanium-doped Nb3Al and present a comparison with MgB₂. In situ wires were made and an interface layer of MgCu₂ characterised. Neutron irradiation provided improved J_{c} at high magnetic field strengths.

Serquis A. et al (A Serquis, L Civale, J Y Coulter, D L Hammon, X Z Liao, Y T Zhu, D E Peterson, F M Mueller, V F Nesterenko and S S Indrakanti, “Large field generation with a hot isostatically pressed powder-in-tube MgB₂ coil at 25 K”, Superconductor Science and Technology 17 (2004) L35-L37) disclose an ex situ PIT technique using stainless steel tubes, including cold drawing and an intermediate anneal. The authors explain that they prefer to avoid porosity, microcracks and presence of precipitates (e.g. MgO). In the process, an additional 5% Mg is included in the MgB₂ powder packed in the tubes, and the ends of the tubes are sealed, to avoid Mg loss. Microcracks are apparently healed by a recrystallisation process during processing. Results were compared for wires subjected to hot isostatic pressing (HIPing) and ambient pressure annealing. HIPing was carried out at 900° C. for 30 mins at 200 MPa. HIPing is considered to provide a high density of structural defects, being useful for pinning. Such pinning has its greatest effect at higher fields and at temperatures closer to T_{c}. Furthermore, conductors were formed in which the MgB₂ was doped with nanosized SiC (5%).

Pan et al (A V Pan, S Zhou, H Liu and S Dou, “Properties of superconducting MgB₂ wires: in situ versus ex situ reaction technique”, Superconductor Science and Technology 16 (2003) 639-644) aimed to combine features of in situ and ex situ reaction techniques to promote densification of the core without losing grain connectivity. The PIT process used a Fe sheath with MgB₂ powder combined with (Mg+2B) powder. The amount of (Mg+2B) powder used was varied between 0 and 1.

WO 2005/104144 discloses a method of producing MgB₂ wire. The method uses either a completely in situ PIT process (using only Mg powder and B powder) or a combination of an in situ and ex situ PIT process in which MgB₂ powder is mixed with Mg powder and B powder. The copper tube is coated with carbon before working to reduce the wire diameter.

### SUMMARY OF THE INVENTION

The present inventors have realised that a particular potential use of MgB₂ conductors is in high magnetic field applications at intermediate cryogenic temperatures (e.g. at around 20 K). A useful composite superconductor under such conditions requires strong flux pinning and high transport critical current characteristics, but reliable techniques to provide suitable flux pinning for MgB₂ composite conductors in combination with high transport critical current characteristics are not available.

The present invention has been devised in order to address one or more of these problems, and preferably to ameliorate, avoid or even overcome one or more of these problems.

Accordingly, in a first aspect, the present invention provides an electrical conductor comprising an elongate composite member having at least one core region including processed core material surrounded by sheath material, different from the processed core material, the processed core material comprising a first component and in situ reacted MgB₂, a major proportion of the first component being interposed between the in situ reacted MgB₂ and the sheath material.

In a second aspect, the present invention provides a method of manufacturing an electrical conductor including the steps:
(a) locating a core material within a sheath material, different from the core material, to form a composite member;
(b) plastically deforming the composite member to provide an elongate composite member having at least one core region including said core material surrounded by at least part of said sheath;
(c) subjecting the elongate composite member to a heat treatment,
   wherein, during step (a), said core material includes a first component and a mixture of Mg-containing material, other than MgB₂, and B-containing material, other than MgB₂, a major portion of said first component being interposed between the sheath material and the mixture of Mg-containing material and B-containing material, and wherein during step (c), the Mg-containing material and the B-containing material react in situ to form MgB₂.

It is considered, without being bound by any particular theory, that the first component may act as a diffusion barrier during thermal processing of the composite member, in order to reduce or suppress a reaction between the in situ reacted MgB₂ (or its starting components) and the sheath material.

It is preferred that the major proportion of the in situ reacted MgB₂ (or the major proportion of the Mg-containing material, other than MgB₂, and B-containing material, other than MgB₂, in the starting materials) is located out of contact with the sheath material. By “major proportion” is intended preferably at least 50 vol % and more preferably at least 60 vol %, at least 70 vol %, at least 80 vol %, at least 90 vol % or substantially all.

Preferably the Mg-containing material is selected from Mg metal and a Mg—H compound, e.g. MgH₂, although in some embodiments this is not preferred. Preferably the Mg-containing material is a powder. Preferably the average particle size is 100 μm or less, more preferably 50 μm or less. In some embodiments, nano-scale particle sizes are preferred for the Mg-containing material, e.g. 1 μm or less, preferably 500 nm, 400 nm, 300 nm, 200 nm, 100 nm or less.

Preferably the B-containing material is selected from pure B and a B-containing compound. Preferably the B-containing material is a powder. Preferably the B-containing material is elemental B, although boron hydride may also be suitable. Preferably the powder has a nanoscale particle size, e.g. 1 μm or less, preferably 500 nm, 400 nm, 300 nm, 200 nm, 100 nm, 50 nm or 20 nm or less, e.g. 10-40 nm. Amorphous or nanocrystalline B is preferred, or a mixture of these materials.

The first component is preferably a compound, and more preferably a compound having two main components, at least one of which is a metal. The first component may comprise ex situ reacted MgB₂. In this case, the location of in situ reaction starting materials adjacent the ex situ reaction MgB₂ may have an effect on the final structure and properties of the ex situ MgB₂. In particular (and again without being bound by theory) it is considered that the use of the in situ reaction starting materials in this way may reduce or suppress Mg loss from the MgB₂ during thermal treatment of the composite member. Furthermore, the first component may act as a diffusion barrier between the sheath and the components used to form the in situ reacted MgB₂.

Preferably, the ex situ reacted MgB₂, before step (a), has an average particle size of about 1 μm or less, e.g. 500 nm or less. For example, preferably the average particle size of the ex situ reacted MgB2, before step (a), is 200 nm or less, preferably 100 nm or less. The lower limit for this average particle size may preferably be 10 nm or more. If the ex situ reacted MgB₂ has a high purity, the present inventors have found that a smaller particle size can be beneficial. A suitable particle size distribution may be such that large particles (e.g. 50 μm or greater) are preferably avoided. This is because a small final diameter for the wire is not compatible with large particle sizes. Larger or large MgB₂ particles may also cause local distortion of the ex-situ/in-situ interfaces.

Preferably, the Mg, or Mg compound other than MgB₂, used as a component of the starting material for the in situ reacted MgB₂, has an average particle size of 1 μm or less. However, in some embodiments it is possible to use relatively coarse Mg powder (particle size in the range 1-100 μm, e.g. 20-60 μm). This may be mixed with B powder (e.g. nanoscale B powder) by milling. The B particles tend to be very hard and thus do not deform significantly during milling. This can lead to a well-mixed Mg—B mixture. A large particle size for Mg means that the Mg powder has a relatively low specific surface area. This can lead to low levels of MgO in the final product, which may be advantageous for some embodiments.

A suitable particle size distribution for the Mg powder is a narrow distribution in (preferably entirely within) the submicron range. However, it is considered that the particle size and particle size distribution of the Mg (or Mg-containing) powder may not have a significant effect on the final microstructure. This is because, during the subsequent heat treatment, the Mg component is typically in the liquid state. The use of a small particle size for the B-containing component can assist in avoiding agglomeration effects in the core and the formation of other phases such as MgB₄ and Mg—Cu oxides.

Preferably, the B, used as a component of the starting material for the in situ reacted MgB₂, has an average particle size of 1 μm or less, preferably 500 nm, 400 nm, 300 nm, 200 nm, 100 nm, 50 nm or 20 nm or less, e.g. 10-40 nm. A suitable particle size distribution is a relatively narrow particle distribution in (preferably entirely within) the submicron range.

Preferably, the ex situ reacted MgB₂, after step (c), has an average grain size of less than 50 μm, preferably less than 20 μm and more preferably 10 μm or less. It is preferred during processing to avoid situations in which deleterious gas can adsorb at the surfaces of the MgB₂ grains. The ex situ reacted MgB₂, after step (c), may have an average grain size of 5 μm or less, more preferably 2 μm or less, 1 μm or less or 500 nm or less. It is preferred that the average grain size of the ex situ reacted MgB₂, after step (c), should be at most 10% of the thickness of the ex situ layer in the conductor. More preferably, the average grain size of the ex situ reacted MgB₂, after step (c), should be at most 5% of the thickness of the ex situ layer in the conductor. An advantage of this is that, during processing of the conductor, since MgB₂ is relatively hard (much harder than Mg but less hard than B), the relatively small average grain size of the ex situ reacted MgB₂ means that it is less likely that any MgB₂ grains will perforate the sheath material. Furthermore, it is also less likely that the ex situ reacted MgB₂ material will cause unwanted deformation defects in the central region of the core.

Preferably, the in situ reacted MgB₂, after step (c), has an average grain size of 1 μm or less, preferably 500 nm, 400 nm, 300 nm, 200 nm, 100 nm, 50 nm or 20 nm or less, e.g. 10⁻⁴⁰ nm.

It is preferred that, after step (c), either the ex situ portion or the in situ portion of the core (or more preferably both) have MgB₂ grains of grain size such that 95% by volume of MgB₂ is made up of grains of grain size 5 μm or less. Still further, it is preferred that there are no MgB₂ grains of grain size 5 μm (or 3 μm) or larger. The effect of this feature depends to an extent on the diameter of the core, becoming more important for narrow cores.

Particle size and/or grain size analysis may be carried out using standard techniques such as particle size analysis (e.g. fluid-based particle size analysis), He adsorption/desorption method, and SEM (e.g. in backscattering mode) or TEM analysis. Preferably grain size analysis of the ex situ reacted MgB₂ and/or of the in situ reacted MgB₂ is carried out using SEM analysis of ground and polished cross sections of the composite conductor. The grain size may be measured using the well-known linear intercept method.

Preferably the peripheral portion of the core, after step (c), has MgB₂ that comprises at least 60%, at least 70%, at least 80%, at least 90% or substantially all ex situ reacted MgB₂. Preferably the central portion of the core, after step (c), has MgB₂ that comprises at least 60%, at least 70%, at least 80%, at least 90% or substantially all in situ reacted MgB₂. Percentages given here can be volume % or weight %, since there is no substantial difference between these in this case.

The term MgB₂ is intended to encompass materials based on the magnesium diboride system, including partial substitutions of Mg, B, or both. Therefore the term MgB₂ may more properly be written (Mg₁₋ₓMₓ) (B_{1-y}R_{y})₂ where M is one or more elements other than Mg and R is one or more elements other than B, x is less than unity (preferably zero) and y is less than unity (preferably zero). The material is superconducting at temperatures below T_{c} for that material. T_{c} varies with composition. R may be Al. Other suitable substituents include Si, C, N, Ga, O, n-diamond or spectral pure nano carbon.

Preferably, the core material of the composite conductor, before step (c), has a volume porosity of 50% or less (preferably 30% or less) of the theoretical compaction possible by cold isostatic pressing (CIP-ing) at 0.4 GPa in Ar. Preferably, the core material of the composite conductor, after step (c), has a volume porosity of 50% or less, but this may be significantly lower, e.g. 40% or less, 30% or less, 20% or less or 10% or less. A cold isostatic pressing step before step (c) may assist in achieving such high densities. Preferably, before step (c), the density of the ex situ layer in the core is 70% or more (or 80% or more) of the theoretical density. The average pore size and size distribution may be similar to or the same as the average particle size and distribution in the core of the conductor.

The first component may be located in a peripheral portion of the core region. In that case, the in situ reacted MgB₂ may be located in a central portion of the core region. In practical conductors according to embodiments of the invention, there will not usually be a sharp interface between the peripheral portion and the central portion. Preferably the interface between these portions is defined as the surface joining the parts of the core material having for example 50% in situ reacted MgB₂ and 50% first material (e.g. ex situ reacted MgB₂).

Preferably the interface between the peripheral portion and the central portion of the core region is located at a distance of from 5% to 45% of the thickness of the core, measured from the interface between the core and the sheath material. The lower limit of this distance may be 10%, 15%, or 20%. The upper limit of this distance may be 40%, 35% or 30%. These limits are combinable in any combination. Most preferably this distance is about 25%.

Preferably the conductor has a rounded cross sectional shape. Most preferably, the cross sectional shape is circular. Such shapes have advantages over flattened PIT conductors, particularly in magnet applications. In contrast with some high T_{c} copper oxide-based superconductors, it has been found that the MgB₂ system does not have a strong dependence of current transport characteristics with grain alignment or texturing, and so a rounded wire configuration may be acceptable.

Preferably the conductor has exactly one core region. This is in contrast with multifilamentary wires. The use of a single core region allows the fill factor of the PIT conductor to be maximised. Preferably the superconducting core fill factor of the conductor is at least 30%, more preferably at least 35%, at least 40%, at least 45%, or at least 50%. The superconducting core fill factor may be at least 60% or at least 70%. This allows the conductor to achieve high engineering values for critical current density.

In an alternative embodiment, the present invention may be applied to multifilamentary conductors in which individual subfilaments are stacked together to form the multifilamentary conductor.

Conductors according to preferred embodiments of the invention may have a transport J_{c} at 4.2 K of 10⁴ A/cm² (or 2×10⁴ A/cm²) or higher at magnetic flux densities of 10 T or higher, e.g. at 11 T, 12 T, 13 T, 14 T or even 15 T or higher, using an electric field criterion of 1 μV/cm.

Conductors according to preferred embodiments of the invention have a relationship between pinning force and magnetic flux density at 4.2 K in which the maximum of pinning force occurs at magnetic flux densities of 10 T or higher, preferably 11 T, 12 T, 13 T, 14 T, or 15 T or higher. For certain conductors according to preferred embodiments, there may be two (or more) maxima of pinning force with magnetic flux density. In that case, the first maximum may be at magnetic flux densities of 10 T or below, more preferably at 9 T, 8 T, 7 T, 6 T, or 5 T or below, e.g. at or below 4 T.

Preferably in the finished conductor the peripheral portion of the core region has different superconducting properties from the central portion of the core region. For example, these portions of the core may have different J_{c} values at the same temperature, and/or different pinning forces at the same temperature, and/or different J_{c} versus B behaviour at the same temperature. These relationships may differ at different temperatures. This allows the core to carry a major proportion of a superconducting current in one portion of the core at a first set of conditions of temperature and magnetic flux density, and a major proportion of the superconducting current in another portion of the core at a second, different set of conditions of temperature and magnetic flux density. In this way, the present invention may provide a superconducting member having a graded core region, different portions of the core being adapted for particular use at different conditions of temperature and/or magnetic flux density.

In the method, it is preferred that, during step (c), the first material acts as a diffusion barrier between the sheath material and the mixture of Mg and B.

Preferably, the first material comprises pre-reacted MgB₂.

Preferably, the sheath material comprises or consists of Cu (and optionally also incidental impurities) or is a Cu-based alloy. Cu is a preferred material since it allows for electrical and/or thermal stabilization of the conductor in the event of a superconductor quench.

Preferably, during step (c), the elongate composite member is also subjected to pressure. It is most preferred that the pressure applied during step (c) is substantially isostatic. The pressure applied during step (c) is preferably at or greater than 200 MPa, and more preferably greater than 300 MPa, greater than 400 MPa, greater than 500 MPa, greater than 600 MPa, greater than 700 MPa, greater than 800 MPa, greater than 900 MPa, and most preferably about 1 GPa. Lower HIP pressures are possible where the core materials have a fine grain size, and/or when the sintering temperature is increased. For example, it is possible to apply a pressure (preferably isostatic pressure) during step (c) of at least 10 MPa. More preferably this pressure is at least 15 MPa or at least 20 MPa. The advantage here is in providing a composite conductor that is readily suited to industrial scale manufacture.

Preferably, the heat treatment of step (c) comprises a relatively fast heat treatment. For example, the isostatic pressure may be applied at a time of X minutes before heat treatment, where X is preferably at least 5 and at most 60. X=15 is acceptable. The temperature applied during HIP-ing is preferably 600-800° C. The time of HIP-ing may be in the range 10 minutes to 1 hour.

Preferably, during the heat treatment, pressure is applied to the conductor so that a well interconnected microstructure is formed at least in the ex-situ MgB₂ portion and also so that the in situ portion can be formed with either low or closed porosity (porosity possibly arising due to the volume change associated with the reaction of Mg and B to form MgB₂).

Preferably the core portion of the conductor includes a population of non-MgB₂ particles. These can assist in increasing the flux pinning strength of the superconducting core. Preferably the average particle size of this population is in the range 2-50 nm, e.g. around 20 nm. It is preferred that the particles are formed from SiC. The preferred shape for these particles is equi-axed, e.g. substantially round. Preferably the proportion of non-MgB₂ particles is 2 vol % or more, more preferably 5 vol % or more, more preferably about 5-10 vol %. Inclusion of such materials may also assist in the formation of a core region of high density, even before step (c).

At least part of the population of non-MgB₂ particles is introduced into the core portion before heat treatment, e.g. as part of the starting materials for the conductor.

The population of non-MgB₂ particles may be present in the first component and/or in the in situ reacted MgB₂.

In a third aspect, the present invention provides an electrical conductor comprising an elongate composite member having at least one core portion including processed core material surrounded by sheath material, different from the processed core material, the processed core material comprising ex situ reacted MgB₂ and a second component, a major proportion of the ex situ reacted MgB₂ being interposed between the second component and the sheath material.

In a fourth aspect, the present invention provides a method of manufacturing an electrical conductor including the steps:
(a) locating a core material within a sheath material, different from the core material, to form a composite member;
(b) plastically deforming the composite member to provide an elongate composite member having at least one core portion including said core material surrounded by at least part of said sheath;
(c) subjecting the elongate composite member to a heat treatment,
   wherein, during step (a), said core material includes ex situ reacted MgB₂ and a second component, a major portion of said ex situ reacted MgB₂ being interposed between the sheath material and the second component, and wherein during step (c), ex situ reacted MgB₂ forms an interconnected microstructure.

Preferably the second component comprises Mg but is preferably other than MgB₂. For example, the second component may comprise a Mg rod, or a powder consolidated into a rod. Dopants may be included where appropriate.

Preferably, features of the first and/or second aspects, and one or more of the preferred and/or optional features set out with respect to the first or second aspect, are applicable (either singly or in any combination) to the third and/or fourth aspect.

Preferably the second component includes an Mg-containing material, However, it is preferred that the second component is not Mg alone. Most preferably the second component consists of a mixture of Mg (or compound containing Mg, other than MgB₂) and B. Preferably the molar ratio of Mg to B is substantially 1:2. This may be a stoichiometric mixture, capable of forming substantially pure MgB₂ after suitable heat treatment.

### BRIEF DESCRIPTION OF THE DRAWINGS

Preferred embodiments of the invention will now be described by way of example with reference to the accompanying drawings, in which:

FIG. 1 shows a schematic transverse cross sectional view of a conductor according to an embodiment of the invention before heat treatment;

FIG. 2 shows an SEM micrograph of a partial transverse cross sectional view of a composite Cu/[(MgB₂)_{0.9}(SiC)_{0.1}]/[(Mg+2B)_{0.9}(SiC)_{0.1}] wire according to an embodiment of the invention before heat treatment;

FIG. 3 shows a schematic longitudinal cross sectional view of a Cu sheath with core powder located within, for use with an embodiment of the invention;

FIG. 4 shows a schematic transverse cross sectional view of the interactive densification process of the ex situ layer in a conductor according to an embodiment of the invention;

FIG. 5 shows a SEM micrograph of a partial transverse cross sectional view of a conductor according to the present invention after HIP-ing at 750° C. for 15 mins, in which the lateral field of view is about 450 microns across;

FIG. 6 shows a SEM micrograph of a partial transverse cross sectional view of an in situ MgB₂ conductor after annealing in vacuum at 700° C. for 1 hour, for comparison;

FIG. 7 shows the magnetic flux density dependence of critical current density for conductors according to the present invention in contrast with other conductors;

FIG. 8 shows the magnetic flux density dependence of global pinning force for conductors according to the present invention in contrast with other conductors;

FIG. 9 shows a SEM micrograph of a partial transverse cross sectional view of a conductor according to the present invention after HIP-ing at 650° C. for 15 mins (fracture cross section).

### DETAILED DESCRIPTION OF THE PREFERRED EMBODIMENTS

Below are discussed specific examples of MgB₂ conductors according to embodiments of the invention. In order to maximise the critical current performance of Cu-sheathed MgB₂ wires, the present inventors have developed a special architecture consisting of concentric regions of in situ and ex situ material held within a Cu sheath. An ex-situ MgB₂ tube interposed between the copper and an in-situ core has been found to act as a chemical barrier, suppressing the reaction of Cu with Mg. Cu/MgB₂/(Mg+2B) wires, with coaxial in situ and ex situ regions both doped with 10 at. % nano SiC, were fabricated from fine crystalline Mg and amorphous B powders using the powder-in-tube (PIT) method. Conventional drawing methods were used as the final wire-forming processes. The samples were annealed under high pressure Ar gas (Hot Isostatic Pressing, HIP) at 750° C. and 1.0 GPa for 15 min, and the resulting effects on the microstructure and pinning are discussed. Transport measurements conducted in the high field region show that the wires possess superior critical current densities of 3×10⁴ A cm⁻² at 14 T. This significant achievement places high J_{c,eng,} fully stabilised, Cu/MgB₂/(Mg+2B) wires ahead of any practical MgB₂ conductors produced to date.

An important parameter for superconducting materials intended to be used at high magnetic field strengths is the global pinning force Fₚ. In high pinning type II superconductors, Fₚ exhibits scaling behaviour with reduced flux density b=B/B_{c2}.

In bulk MgB₂, well-developed inter-grain connectivity contributes to high J_{c} values under low magnetic fields, and a small MgB₂ grain size enhances grain boundary pinning.

Coated conductors can be formed with high J_{c}, but due to their typically very small superconducting cross sectional proportion, they have low J_{c,eng}.

The present inventors accordingly have investigated round PIT wires using MgB₂ and Cu sheath (for cryostability) with the aim of providing high J_{c,eng} at high magnetic field strengths with improved flux pinning beyond that available from grain boundary pinning, by the introduction of numerous defects and inclusions into the MgB₂ structure. This is achieved in part using a HIP process in which the MgB₂ is contained within a Cu sheath and subjected to a relatively short heat treatment, in order to provide core densification. The provision of artificial pinning centres is also investigated. Nano-scale MgO, at low addition levels (e.g. 2.5 wt % or less) can be beneficial. However, SiC nanoparticles are preferred.

Among numerous binary compounds, the use of SiC nanoparticles to improve high field pinning is a very appealing approach due to its potential for a dual effect. The first of these is Mg₂Si nanoprecipitation:

2Mg+SiC→Mg₂Si+C

The second is substitution of B by C:

MgB₂+C→Mg(B₁₋ₓCₓ)₂

Both of these can be considered advantageous in view of improving properties of ex situ and/or in situ MgB₂ superconducting behaviour. In the present work, 10 at % SiC is used.

A generally recognized weaknesses of Cu in situ conductors for applications in higher magnetic fields is the strong interaction of Mg with Cu, which causes the unwanted formation of MgCu₂, and lack of compressive forces introduced by the soft copper matrix, which prevents the achievement of high current densities in a high magnetic field. The inventors address these issues in the present work in particular for single core round conductors, providing superior J_{c}(B) and J_{c,eng}(B) characteristic at high magnetic field.

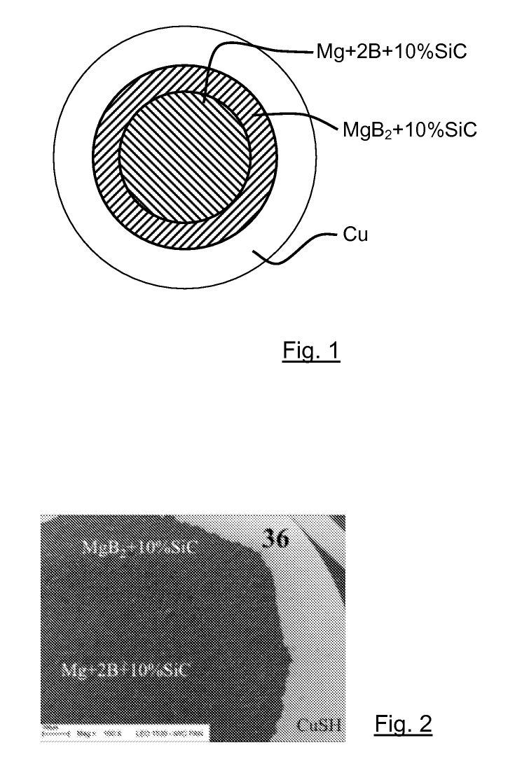

The composite Cu/[(MgB₂)_{0.9}(SiC)_{0.1}]/[(Mg+2B)_{0.9}(SiC)_{0.1}] conductor was assembled using a modified PIT technique in which a central in-situ Mg+2B core was surrounded by a concentric ex-situ MgB₂ tube acting as a diffusion barrier. A schematic transverse cross sectional view is shown in FIG. 1. A partial transverse cross sectional view of a sample is shown in FIG. 2.

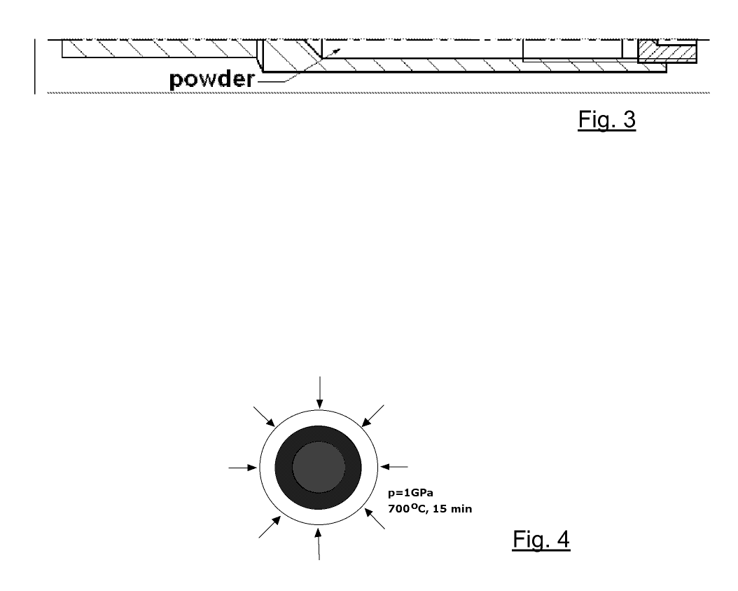

For the starting in situ powders, Mg (99.8% purity, particle size around 150 μm, although smaller particles can be used) from Alfa Aesar and amorphous B (particle size 10-30 nm), were ultrasonically mixed and cleaned in the nominal stoichiometry of MgB₂ and 10% SiC from Nanostructured & Amorphous Materials Inc. was added. In-situ powders were densified by cold isostatic pressing (CIP) at an argon pressure of 0.3 GPa. The in situ core was placed centrally in ex situ MgB2 powder (particle size 10-100 nm, although particle sizes up to 1 μm my be acceptable) from Alfa Aesar doped with 10 at. % of nanometre-sized SiC and was cold isostatically pressed in argon at 0.3 GPa. This sequential CIP process assures exceptional density of the MgB₂ after sintering and enables the integrity of the coaxial architecture to be preserved. The resulting composite rod was inserted in a 15 cm long, 13.8 mm external diameter copper tube (see FIG. 3, in which the dashed line represents the principal axis of the copper tube, and the lower half of the longitudinal cross section view of the copper tube only is shown) which was then closed. The assembly process was conducted in an Ar atmosphere, because of the high reactivity of Mg with oxygen. The closed copper tube was drawn to a wire of 1.1 mm in diameter.

Before heat treatment, it was found that the core could attain densities of 85% of theoretical. It was found that the inclusion of 10% SiC allowed core densities of up to 98% of theoretical. The core fill factor was about 70%.

After drawing, the wire was cut into 9 cm long pieces which were then annealed in a high pressure chamber, (see FIG. 4 showing a schematic of the HIP process), under a high isostatic Ar gas pressure of 1.0 GPa, at a temperature of 750° C., for 15 minutes. Alternative embodiments use different temperatures, e.g. 650° C., and may use different times, e.g. up to 60 minutes. Furthermore, lower pressures may be used, e.g. about 20 MPa. It is considered that lower temperatures in the preferred range may provide nanometre-scale porosity, whereas higher temperatures in the preferred range may provide micron-scale porosity.

The DC transport critical current (I_{c}) was measured using a four point technique and a 1 μV cm⁻¹ electric field criterion in a Bitter-type magnet, and also in a superconducting magnet, in liquid helium. In both cases, the transport current capabilities of the measurement systems and the maximum magnetic field achievable limited measurements to the 10-14 T range.

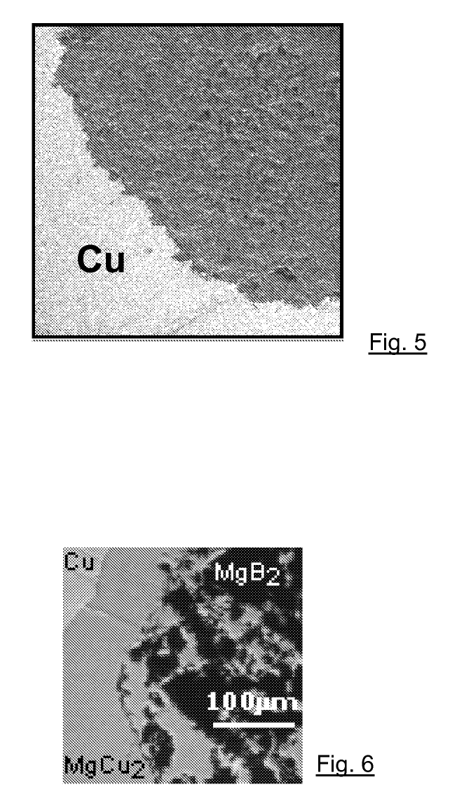

After HIP at 750° C. for 15 min the superconducting core was very dense and the interface between the ex-situ and in situ regions was much less apparent. This is shown in FIG. 5. FIG. 5 shows an SEM micrograph of Cu/[(MgB₂)_{0.9}(SiC)_{0.1}]/[(Mg+2B)_{0.9}(SiC)_{0.1}] conductor HIPed at 750° C. for 15 min. For comparison, FIG. 6 shows a Cu(Mg+2B) conductor annealed under vacuum at 700° C. for 1 h (i.e. a fully in situ reacted core). As seen in FIG. 5, where an embodiment of the present invention is adopted, there is a dramatic improvement in the integrity of the MgB₂ microstructure and a lack of interdiffusion between the Mg and Cu matrix, in comparison with FIG. 6.

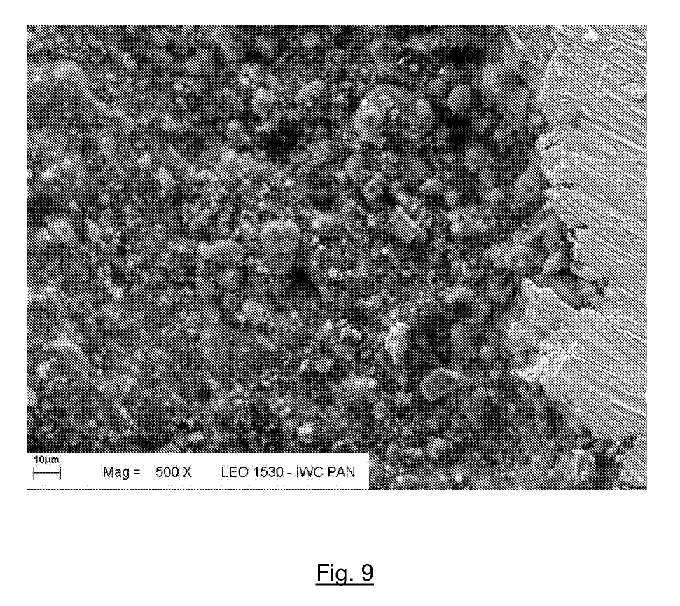

FIG. 9 shows a SEM fracture cross section of a conductor according to an embodiment of the invention (HIP at 650° C. for 15 mins). The right hand side of this micrograph shows the Cu sheath. In contact with the Cu sheath is a layer of ex situ reacted MgB₂. At the bottom left side of this micrograph is shown in situ reacted MgB₂. The interface between the ex situ reacted MgB₂ and the in situ reacted MgB₂ is difficult to discern in this fracture cross section. However, it can be seen that the grains in the core (substantially all MgB₂) have a relatively small average grain size and a relatively narrow grain size distribution.

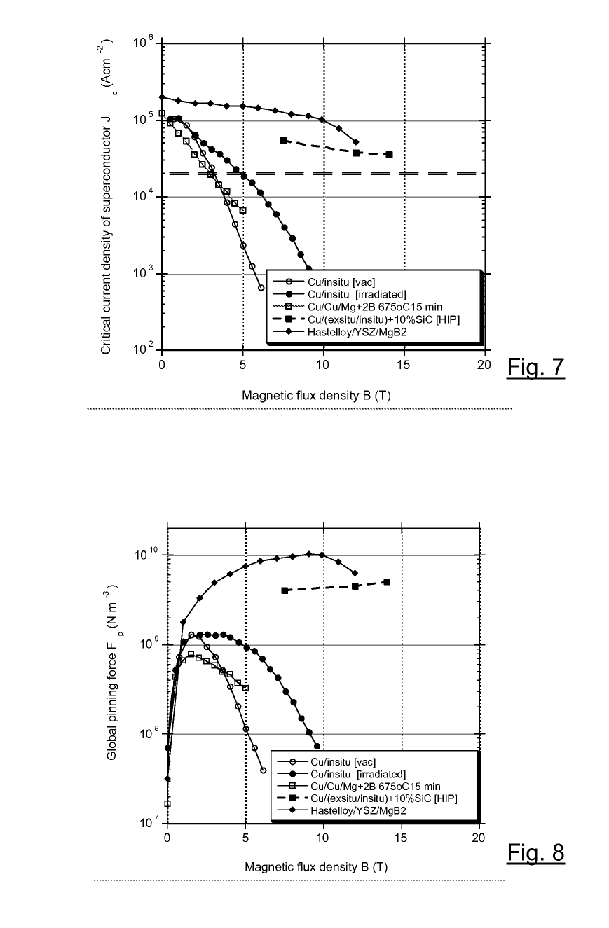

The magnetic flux density dependence of critical current density and global pinning force are presented for the Cu-based wires in FIGS. 7 and 8, respectively. For comparison, data for three other Cu-based wires and a MgB₂ coated conductor are presented. The J_{c} value for continuously formed double jacketed Cu/Cu/MgB₂ wires by the CTFF powder filling technique (an implementation of the widely used welding electrode manufacturing technique) is typical for Cu-matrix conductors, and also J_{c,eng} was low (from M. Bhatia, M. D. Sumption, M. Tomsic and E. W. Collings, Physica C: Superconductivity, Volume 407, Issues 3-4, 15 Aug. 2004, Pages 153-159). In Cu/(Mg+2B) neutron-irradiated conductors the irreversibility line becomes steeper after irradiation, leading to higher irreversibility fields at low temperatures (an increase from 7.7 T to 12.1 T at 4.2 K). A high density of defects is introduced and there is a noticeable improvement of J_{c} value at moderate magnetic fields, but this approach is not significant for practical applications (see Glowacki B A 1999 Intermetallics 7 117). The horizontal line in FIG. 7 at the critical current density of 2×10⁸ A m⁻² is a generally accepted limit for power applications. It is evident from FIG. 7 that the Cu/[(MgB₂)_{0.9} (SiC)_{0.1]/[(Mg+}2B)_{0.9}(SiC)_{0.1}] coaxial composite conductor has a J_{c} exceeding this value in the 14 T region. In the proposed architecture, the MgB₂ diffusion barrier also contributes to the critical current, and applying an external isostatic pressure during sintering removes the need to add reinforcing materials not contributing to cryo-stabilisation of the conductor. Consequently, the process can secure fine-grained MgB₂ characterised by high J_{c} and high J_{c,eng} in medium and high magnetic fields. The proposed Cu/MgB₂/(Mg+2B) design with SiC nanoparticles is considered to be highly applicable for higher magnetic fields suitable for fusion and NMR magnets above 10 T. Also considering the pinning contribution in the 3 T range, such round high J_{c,eng} conductors are considered highly suited for adiabatic demagnetisation refrigeration (ADR) applications.

It is considered by the present inventors that the inclusion of artificial pinning centres (APC) results in two coexistence pinning mechanisms, namely grain boundary pinning (leading to a global pinning force peak at around 2 T) and APC such as secondary phases, precipitates, stacking faults, local dimensional crossover between mechanically induced defects, chemically induced pressure and excess or deficiency of constituent elements (leading to a global pinning force peak at around 19 T). Stacking faults are considered to be particularly important here.

It is apparent that interdiffusion is negligible between Cu and Mg in the conductors of the embodiments of the invention at the interface between Cu and ex situ MgB₂, see FIG. 5 compared with FIG. 6. The isostatic pressure was introduced at room temperature before sintering of B and Mg took place. 750° C. is a low sintering temperature for ex situ MgB₂ (in the external layer) but it was anticipated that some of liquid magnesium from the in situ central core may help to consolidate ex situ MgB₂ under high isostatic pressure. The whole reaction process of consolidation, reaction, substitution and precipitation in the SiC-doped ex situ/in situ conductor took only 15 min.

It is considered that the cause of the pinning increase in high magnetic fields in embodiments of the present invention may be due to the basic mechanism of diffusion of Mg to B, via a network of channels in the B grains to form corresponding channels of MgB₂.

In theory, MgB₂ formed by diffusion of Mg to B particles should exhibit about 25.5% decrease in density from the initial density value due to the phase transformation. Results achieved by infiltration of the finest B powders showed a dense and uniform MgB₂ product (see Giunchi G, Ripamonti G, Perini E, Ginocchio S, Bassani E and Cavallin T 2006 Advances in Science and Technology 47 7). Therefore when the HIP process is applied, the central in situ core may reach or approach the theoretical density.

In another in situ experiment it was established that the resulting MgB₂ particle size (20-100 nm), was much less than that of the original magnesium powders (80-200 nm) and boron powders (70-140 nm). The nucleation density of MgB₂ particles is high, and the small particle size is considered to be favoured by the difficulties of growth. These discrepancies in final MgB₂ sizes may be explained by fragmentation of the B particles during growth. The structure of the particles appears to be rather perfect as there was no evidence of dislocations. Furthermore, the lattice planes continue undistorted close to the particle surface. It has been reported that the large forces applied during cold working induced a large MgB₂ lattice deformation, and partial relaxation during sintering has an important correlation of the residual stress with the critical temperature and the pinning properties (see Bellingeri E, Malagoli A, Modica M, Braccini V, Siri A S and Grasso G 2003 Supercond. Sci. Technol. 16 276).

It may be expected that hot isostatic processing of the coaxial round wires disclosed here introduces a radial pressure on the ex situ MgB₂ core through the soft copper, and this could induce lattice deformation and nanocracking of MgB₂. More importantly, one may expect that, under pressure, some Mg from the in situ part of the core may penetrate the induced defects of the ex situ part of the conductor providing some magnesium excess, creating APC in MgB₂ grains. It has been established that an excess of Mg in MgB₂ under hot uniaxial pressing is present in the final composite in unreacted form. If the idea that some Mg from an internal in situ core is ‘extruded’ into the intragranular regions of the ex situ MgB2 shell then the layer of Mg-vacancies may form insulating regions in the in situ layer. Particularly enhanced in Mg_{0.975}B₂, the effect upon the magnetic response resembled that of a columnar-like structure that percolated throughout the length of the sample (see Passos W A C, Sharma P A, Hur N, Guha S, Cheong S W and Ortiz W A 2004 Physica C 408-410 853).

The results of various transport experiments on Mg₁₋ₓB₂ indicated a surprising effect associated with Mg deficiency in MgB₂. This was a phase separation between Mg-vacancy rich and Mg-vacancy poor phases. The Mg-vacancy poor phase was superconducting, but the insulating nature of the Mg-vacancy rich phase probably arose from Anderson (disorder-induced) localization of itinerant carriers (see Sharma P A, Hur N, Horibe Y, Chen C H, Kim B G, Guha S, Cieplak M Z and Cheong S W 2002 Physical Review Letters 89 167003). Data for bulk samples of MgₓB₂ with starting compositions of x from 0.5 to 1.3, prepared using a solid-state reaction, have shown that the Mg-deficient samples exhibited higher J_{c} values at high magnetic field. The highest irreversibility field of Hᵢᵣᵣ=5.2 T at 20 K was reached for x=0.8. The formation of MgB₄ nanoparticles may also be responsible for the increase of Hᵢᵣᵣ and J_{c} (see Xu G J, Pinholt R, Bilde-Srensen J, Grivel J C, Abrahamsen A B and Andersen N H 2006 Physica C 434 67).

In the present embodiments, very high J_{c} values at 14 T have been observed in SiC-doped Cu/in situ/ex situ conductors produced by hot isostatic pressing. It is expected that the structure producing the enhanced high-field pining behaviour arises from a complex combination of densification, reaction, substitution and precipitation behaviour in the presence of local variations of magnesium excess and deficiency.

The embodiments above have been described by way of example. On reading this disclosure, modifications of these embodiments, further embodiments and modifications thereof will be apparent to the skilled person and as such are within the scope of the present invention.

1. An electrical conductor comprising an elongate composite member having at least one core region including processed core material surrounded by sheath material, different from the processed core material, the processed core material comprising a first component and in situ reacted MgB₂, a major proportion of the first component being interposed between the in situ reacted MgB₂ and the sheath material.

2. An electrical conductor according to claim 1 wherein a major proportion of the in situ reacted MgB₂ is located out of contact with the sheath material.

3. An electrical conductor according to claim 1 wherein the first component comprises ex situ reacted MgB₂.

4. An electrical conductor according to claim 1 wherein the first component is located in a peripheral portion of the core region and the in situ reacted MgB₂ is located in a central portion of the core region.

5. An electrical conductor according to claim 4 wherein an interface between the peripheral portion and the central portion of the core region is located at a distance of from 5% to 45% of the thickness of the core.

6. An electrical conductor according to claim 1 having exactly one core region.

7. An electrical conductor according to claim 1 having a superconducting core fill factor of at least 30%.

8. An electrical conductor according to claim 1 having a transport J_{c} at 4.2 K of 10⁴ A/cm² or higher at magnetic flux densities of 10 T or higher.

9. An electrical conductor according to claim 4 wherein the peripheral portion of the core region has different superconducting properties from the central portion of the core region.

10. An electrical conductor according to claim 1 wherein the sheath material comprises Cu as a major component.

11. An electrical conductor according to claim 1 wherein the core portion of the conductor includes a population of non-MgB₂ particles providing flux pinning sites.

12. An electrical conductor according to claim 11 wherein the non-MgB₂ particles comprise SiC particles.

13. A method of manufacturing an electrical conductor including the steps:
(a) locating a core material within a sheath material, different from the core material, to form a composite member;
(b) plastically deforming the composite member to provide an elongate composite member having at least one core region including said core material surrounded by at least part of said sheath;
(c) subjecting the elongate composite member to a heat treatment,
wherein, during step (a), said core material includes a first component and a mixture of Mg-containing material, other than MgB₂, and B-containing material, other than MgB₂, a major portion of said first component being interposed between the sheath material and the mixture of Mg-containing material and B-containing material, and wherein during step (c), the Mg-containing material and the B-containing material react in situ to form MgB₂.

14. A method according to claim 13 wherein the first component acts as a diffusion barrier between the sheath and the components used to form the in situ reacted MgB₂.

15. A method according to claim 13 wherein the core material of the composite conductor, before step (c), has a volume porosity of 50% or less of the theoretical compaction possible by cold isostatic pressing at 0.4 GPa in Ar.

16. A method according to claim 13 wherein, before step (c), a cold isostatic pressing step is carried out.

17. A method according to claim 13 wherein the first material comprises pre-reacted MgB₂.

18. A method according to claim 13 wherein the sheath material comprises Cu as a major component.

19. A method according to claim 13 wherein, during step (c), the elongate composite member is also subjected to isostatic pressure.

20. A method according to claim 19 wherein the pressure applied during step (c) is 10 MPa or greater.

21. A method according to any one of claim 19 wherein the temperature applied during step (c) is 600-800° C.
